(19) United States
(12) Patent Application Publication
(10) Pub. No.: US 2021/0190022 A1
(43) Pub. Date: Jun. 24, 2021

(54) Method for Preventing Icing of an Injection System of an Internal Combustion Engine

(71) Applicant: Bayerische Motoren Werke Aktiengesellschaft, Muenchen (DE)

(72) Inventor: Manfred LAUER, Ainhofen (DE)

(21) Appl. No.: 16/759,168

(22) PCT Filed: Sep. 17, 2018
(86) PCT No.: PCT/EP2018/074991

§ 371 Date: Apr. 24, 2020

(30) Foreign Application Priority Data
Oct. 27, 2017 (DE) 10 2017 219 369.7

(51) Int. Cl. F02M 43/02; F02M 25/022; F02M 25/025

(52) U.S. Cl. CPC F02M 43/02; F02M 25/025; F02M 25/0224

(57) ABSTRACT

A method prevents icing of an injection system of an internal combustion engine of a motor vehicle having a high-pressure fuel pump to which, in addition to fuel, water can also be supplied via a feed line. When the motor vehicle is stopped, water still located in a wide region of the feed line is extracted, at least if required. For this purpose, a conveying device provided for conveying water to the high-pressure fuel pump is operated with the direction of rotation reversed. When the motor vehicle or the internal combustion engine is re-started, that region of the feed line from which water located therein has previously been extracted is flushed with water, the air located therein beings discharged into the surroundings.

### BACKGROUND AND SUMMARY OF THE INVENTION

The invention relates to a method for preventing icing of an injection system of an internal combustion engine of a motor vehicle having a high-pressure fuel pump to which not only fuel but also water can be fed via a feed line. The invention also relates to an advantageous device for carrying out the method according to the invention.

In the future, increasing use will be made of vehicle internal combustion engines in which the combustion of fuel has water admixed to it at least at certain operating points. This water is preferably extracted from an on-board reservoir and conveyed by means of a conveying device to at least one injection valve which injects a certain water quantity for example into the air intake system of the internal combustion engine or into (in each case) one of the combustion chambers thereof. The present invention relates to a system in which the existing fuel injection valves assigned to the individual combustion chambers of the internal combustion engine are also used to inject the desired water, specifically in the form of an emulsion which is formed in a high-pressure fuel pump to which not only the fuel but also, in a manner dependent on the respective operating point of the internal combustion engine, water is fed for the purposes of compression.

If the motor vehicle, after operation in cold seasons, is shut down for a period of time of several hours, it would be possible for water that is still situated in a feed line to the high-pressure fuel pump to freeze, as a result of which, it would not be possible for water to be fed to the combustion chambers for a relatively long period of time after restarting of the internal combustion engine. Also, the feed line itself could be damaged by ice pressure. By contrast, small water fractions in an emulsion (composed of fuel and a certain amount of water)—if such water fractions are present at all—do not cause damage.

It is an object of the present invention to provide a remedial measure for this highlighted problem.

This object is achieved by means of a method wherein, when the motor vehicle is in a shut-down state, the water still situated in an extensive region of the feed line is extracted by suction at least as required (specifically possibly in a manner dependent on the ambient temperature). Preferably, the water that has been extracted by suction is conducted back into a reservoir from which, during the operation of the internal combustion engine, a conveying device conveys water to the high-pressure injection pump as required. Further advantageous embodiments and refinements, also in the form of a corresponding device for carrying out the method according to the invention, are claimed herein.

It is proposed that, after a shutdown of the vehicle at least in cold seasons, the water (as liquid which is at risk of freezing) ideally be conveyed back into the reservoir, wherein this may, in order to minimize the outlay in terms of construction, be performed by means of an existing conveying device by reversal of the conveying direction thereof, by virtue of the conveying device extracting the water from the feed line by suction. Here, however, no fuel should pass from the high-pressure fuel pump, or from a fuel line which supplies fuel from a fuel tank of the vehicle to the high-pressure fuel pump, into the reservoir. It is therefore also proposed that a valve be provided in the feed line as close as possible to the high-pressure fuel pump, or preferably as close as possible to, and ideally directly upstream of, a merging point (“line merging point”) of the feed line with a fuel line leading to the high-pressure fuel pump, which valve closes, or is in a closed state, during the (or a short time before an) extraction of water from the feed line by suction. The valve may be either a check valve which blocks in the direction of the conveying device for water or may be a switchable shut-off valve which, like the conveying device, is suitably activated by an electronic control unit.

In order to ensure a successful extraction of the water from the feed line by suction, that end of the feed line which faces toward the above-stated check valve or shut-off valve should be capable of being aerated, for which reason there is also proposed a line branch which, as viewed in a conveying direction of the conveying device during the operation of the internal combustion engine, branches off from the feed line upstream of the stated check valve or shut-off valve and opens into the surroundings. It is then possible for air from the surroundings to pass through the line branch into the feed line, such that no negative pressure forms in the feed line during the extraction of the water by suction. In order to prevent dirt particles from passing out of the surroundings into the feed line in the process, an air filter device must be provided at the free end portion of the line branch.

In order to prevent a situation in which, upon a restart of the motor vehicle or more specifically of the internal combustion engine thereof, water that is then conveyed by the conveying device to the high-pressure fuel pump passes through the line branch into the surroundings, it is expediently the case that, in the line branch, there is provided a check valve, which opens toward the conveying device, or preferably a suitably switchable shut-off valve. The latter is specifically particularly advantageous because, with this, it is possible to prevent a situation in which, during a refilling of the feed line with water, the air that is still situated in the feed line initially passes into the high-pressure fuel pump. As the conveying device initially conveys water after a restart of the internal combustion engine, the shut-off valve in the line branch initially is or remains (with suitable activation) open until such time as water is conveyed through the line branch (into the surroundings). Only thereafter is the shut-off valve transferred into the closed state preferably by the abovementioned electronic control unit. This is correspondingly also worded as a method claim. In order, during this so-called flushing of the feed line with water, during which air is displaced out of the feed line through the line branch into the surroundings, to protect an air filter element which is provided in the air filter device (in the line branch) from being impinged on with water, a suitably designed water outlet is provided for the air filter device, which water outlet prevents water arriving from the feed line from impinging on the air filter element to a significant extent.

### BRIEF DESCRIPTION OF THE DRAWING

FIG. 1 is a schematic diagram of an exemplary embodiment.

### DETAILED DESCRIPTION OF THE DRAWING

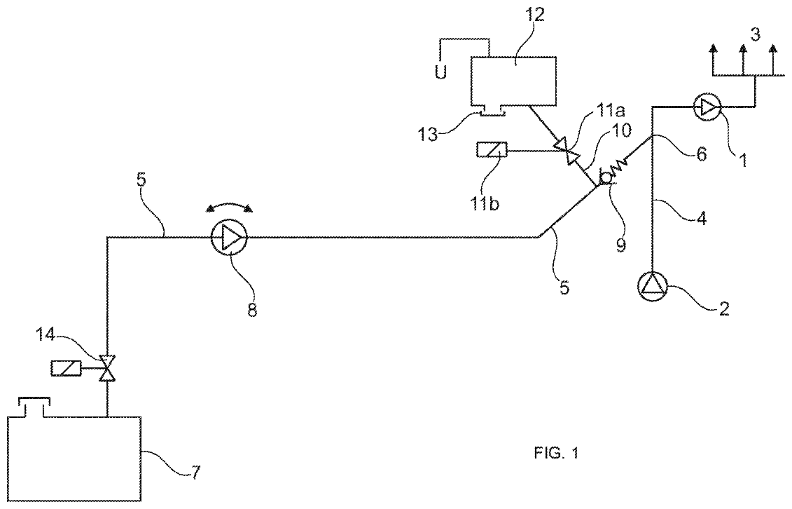

FIG. 1 schematically shows a possible exemplary embodiment. Here, the reference designation 1 denotes a high-pressure fuel pump by means of which, during the operation of a vehicle internal combustion engine (not shown), fuel which is conveyed by means of an in-tank pump 2 through a fuel line 4 from a fuel tank (not shown) to the high-pressure fuel pump 1 is normally further compressed and provided to multiple injection valves 3, which (can) inject the compressed fuel into combustion chambers of the internal combustion engine.

In the present case, instead of pure fuel, it is also possible as required for an emulsion of fuel and water to be introduced through the injection valves 3 into the combustion chambers. The water is admixed as required to the fuel quantity fed to the high-pressure fuel pump 1, for which purpose a feed line 5 which conducts the water in opens into the fuel line 4 via a suitably designed line merging point 6. The required water is conveyed in by the feed line 5 from a reservoir 7 by means of a conveying device 8 which is arranged in this case outside the reservoir 7, which conveying device is normally designed as a pump. The conveying device 8 can selectively convey water from the reservoir 7 through a check valve 9, described in the next paragraph, to the fuel line 4, or can be operated with a reversed direction of rotation or conveying direction and thus convey water that is situated in the feed line 4 out of an extensive region of the feed line back into the reservoir 7.

As discussed in detail prior to the description of the FIGURES, in the feed line 5 upstream (as viewed in a conveying direction of the conveying device 8 during the operation of the internal combustion engine) of the line merging point 6, as close as possible or directly upstream of this or upstream of the fuel line 4, there is provided a check valve 9 which blocks in the direction of the conveying device 8. A line branch 10, likewise discussed prior to the description of the FIGURES, branches off from the feed line 5 substantially directly upstream of the check valve 9, which line branch ultimately opens into the surroundings U. In the line branch 10, as viewed from the feed line 5 in the direction of the surroundings U, there is provided firstly a shut-off valve 11a, which can be actuated by means of an electric motor 11b, and then an air filter device 12, which is equipped with a suitably designed water outlet 13, likewise as described further above.

The function of the individual elements shown will not be described once again—this can be found prior to the description of the FIGURE using the same terminology. In addition to the elements already described thus far, a suitably activatable icing prevention valve 14 is also provided in the feed line 4 upstream (as viewed in a conveying direction of the conveying device 8 during the operation of the internal combustion engine) of the conveying device 8, which icing prevention valve, after the feed line 5 has been evacuated by suction (by means of the conveying device 8), is closed for safety purposes at least in the presence of low ambient temperatures. The icing prevention valve 14 prevents water from being sucked into the line 5 as a result of a decrease in size of the enclosed gas volume as the latter cools. At the same time, the valve serves for maintaining pressure without the use of energy, if it is activated, so as to open, only for as long as the conveying device 8 operates.

1.-7. (canceled)

8. A method for preventing icing of an injection system of an internal combustion engine of a motor vehicle having a high-pressure fuel pump to which fuel and also water is feedable via a feed line, the method comprising:
when the motor vehicle is in a shut-down state, extracting water still remaining in an extensive region of the feed line at least as required, wherein
the extraction is by suction.

9. The method according to claim 8, wherein
for the extraction of water by suction, a conveying device provided for conveying water to the high-pressure fuel pump is operated with a reversed direction of rotation.

10. The method according to claim 8, wherein
upon a restart of the motor vehicle or of the internal combustion engine, that region of the feed line from which water present therein was previously extracted by suction is flushed with water, wherein air situated therein is discharged into surroundings.

11. A device, comprising:
a feed line;
a high pressure fuel pump to which fuel and water is feedable via the feed line;
a check valve, or switchable shut-off valve, which is provided in the feed line close to the high-pressure fuel pump or to a merging point with a fuel line leading to the high-pressure fuel pump, wherein the check valve or switchable shut-off valve blocks in a direction of a conveying device for the water.

12. The device according to claim 11, wherein
as viewed in a conveying direction of the conveying device during operation of the internal combustion engine, a line branch which opens into the surroundings branches off from the feed line upstream of the check valve or the shut-off valve.

13. The device according to claim 12, wherein
in the line branch, a check valve or a switchable shut-off valve is provided, which opens in the direction of the conveying device.

14. The device according to claim 13, wherein
in the line branch, an air filter device is provided, which has a water outlet which protects an air filter element from being impinged on with conveyed water.
